(19) United States
(12) Patent Application Publication
(10) Pub. No.: US 2024/0377593 A1
(43) Pub. Date: Nov. 14, 2024

(54) OPTICAL INTEGRATED DEVICE AND PREPARATION METHOD THEREFOR

(71) Applicant: InnoLight Technology (Suzhou) Ltd., Suzhou , Jiangsu (CN)

(72) Inventors: Xue-zhe ZHENG, Suzhou, Jiangsu (CN); Yin-chao DU, Suzhou, Jiangsu (CN); Feng WANG, Suzhou, Jiangsu (CN)

(21) Appl. No.: 18/691,529

(22) PCT Filed: Jul. 1, 2022
(86) PCT No.: PCT/CN2022/103218

§ 371 Date: Mar. 13, 2024

(30) Foreign Application Priority Data
Sep. 14, 2021 (CN) 202111075267.3

(51) Int. Cl. G02B 6/42

(52) U.S. Cl. CPC G02B 6/4204

(57) ABSTRACT

An optical integrated device and a preparation method therefor. The preparation method for the optical integrated device comprises: providing a first substrate (100), and mounting an optical chip (200) on the first substrate (100), the optical chip (200) being used to emit a light beam; providing a second substrate (300), and mounting a modulation chip (400) on the second substrate (300), the modulation chip (400) being used to modulate the light beam emitted by the optical chip (200); providing a connection assembly (500), the connection assembly (500) comprising a first connector (510) and a second connector (520), and the first connector (510) and the second connector (520) matching each other; fixing the second connector (520) to the second substrate (300); connecting the first connector (510) to the second connector (520); adjusting the position of the second substrate (300) relative to the first substrate (100) until the modulation chip (400) and the optical chip (200) achieve optimal optical coupling, and fixing the first connector (510) to the first substrate (100). The present method may greatly reduce the difficulty of the preparation process of the optical integrated device, and improve the production yield of the optical integrated device.

CROSS-REFERENCE TO RELATED PATENT APPLICATION

This is the U.S. national phase application of International Application PCT/CN2022/103218, filed on Jul. 1, 2022, which international application was published on Mar. 23, 2023, as International Publication No. WO/2023/040420. The international application claims priority to China Patent Application No. 202111075267.3, filed on Sep. 14, 2021, in the People's Republic of China, the contents of which are incorporated herein by reference in their entireties.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to the field of optoelectronics technology, and more particularly to an optical integrated device and a preparation method therefor.

### BACKGROUND OF THE DISCLOSURE

With the development of communication technology, optical integrated devices are widely used. At present, most of optical integrated devices are prepared by abutting grown structures on the same substrate. That is, an optical gain active layer and a modulation absorption layer are epitaxially grown separately on the same substrate to achieve monolithic integration. For example, when an electroabsorption modulated laser (EML) is integrated by a distributed feedback (DFB) laser and an electroabsorption (EA) modulator, quantum well structures of an active layer of the DFB laser and an absorption layer of the EA modulator are epitaxially grown separately.

However, the separate epitaxial growths for the optical gain layer and the modulation absorption layer involves multiple etching and epitaxy processes, and the complexity of these processes and the low yield of integrated products may lead to an increase in the cost of the devices.

### SUMMARY OF THE DISCLOSURE

### Technical Problem

In response to the above-referenced technical inadequacies, it is necessary to provide an optical integrated device and a preparation method therefor.

### SOLUTION OF THE PROBLEM

### Technical Solution

A preparation method for an optical integrated device, includes:
providing a first substrate, and mounting an optical chip on the first substrate, the optical chip being used to emit a light beam;
providing a second substrate, and mounting a modulation chip on the second substrate, the modulation chip being used to modulate the light beam emitted by the optical chip;
providing a connection assembly, the connection assembly including a first connector and a second connector, and the first connector and the second connector matching each other;
fixing the second connector to the second substrate;
connecting the first connector to the second connector;
adjusting a position of the second substrate relative to the first substrate until the modulation chip and the optical chip achieve optimal optical coupling, and fixing the first connector to the first substrate.

In one embodiment, the optical chip includes a laser chip, and the modulation chip includes an electroabsorption modulator chip, a silicon-based modulator chip, or a microring modulator chip.

In one embodiment, after providing a first substrate and mounting an optical chip on the first substrate, the preparation method further includes:
mounting a first lens structure on the first substrate, and the first lens structure being located on one side of the optical chip.

In one embodiment, mounting a first lens structure on the first substrate further includes:
adjusting a position of the first lens structure relative to the optical chip;
mounting the first lens structure on the first substrate.

In one embodiment, before fixing the second connector to the second substrate, the preparation method further includes:
connecting and assembling the second connector with a second lens structure.

In one embodiment, after connecting and assembling the second connector with a second lens structure, the preparation method further includes:
focusing and coupling an external collimated beam to the modulation chip through the second lens structure;
adjusting the position of the second lens structure relative to the modulation chip until the modulation chip achieves optimal coupling for the external collimated beam.

In one embodiment, focusing and coupling the external collimated beam to the modulation chip through the second lens structure further includes:
providing an optical fiber collimator assembly, the optical fiber collimator assembly including a third connector, and the third connector and the second connector matching each other;
connecting the third connector to the second connector;
emitting the external collimated beam through the optical fiber collimator assembly.

An optical integrated device includes:
a first substrate, an optical chip being mounted on the first substrate, and the optical chip being used to emit a light beam;
a second substrate, a modulation chip being mounted on the second substrate, and the modulation chip being used to modulate the light beam emitted by the optical chip;
a connection assembly, the connection assembly including a first connector and a second connector, the first connector and the second connector matching each other, the second connector being fixed to the second substrate, and the first connector being fixed to the first substrate.

In one embodiment, the optical integrated device further includes a first lens structure, the first lens structure is located on the first substrate, and is located on a side of the optical chip close to the modulation chip.

In one embodiment, the optical integrated device further includes a second lens structure, the second lens structure is located on the second substrate, and is located on a side of the modulation chip close to the optical chip.

In one embodiment, the second lens structure is assembled on the second connector.

In one embodiment,
the first connector includes a first guide pin and a first guide hole;
the second connector includes a second guide pin and a second guide hole;
the first guide pin is arranged corresponding to the second guide hole, and the second guide pin is arranged corresponding to the first guide hole.

In one embodiment, the optical integrated device further includes a heat dissipation component, the heat dissipation component includes a first heat dissipation plate and a second heat dissipation plate, the first heat dissipation plate is connected to a side of the first substrate where the optical chip is not mounted, and the second heat dissipation plate is connected to a side of the second substrate where the modulation chip is not mounted.

### BENEFICIAL EFFECT OF THE PRESENT DISCLOSURE

### Beneficial Effect

In the above-mentioned optical integrated device and the preparation method therefor, the optical chip and the modulation chip are mounted on different substrates and then connected through the first connector and the second connector of the connection assembly. The matching and mating between high-quality outer surfaces of the first connector and the second connector can ensure that directions of the light beams on both sides are consistent. At the same time, it can effectively avoid the separate epitaxial growths of the optical gain active layer and the modulation absorption layer on the same substrate (i.e., a single substrate), thereby avoiding the high reliability risks associated with performing multiple epitaxial processes for monolithic integration. Moreover, the optical chip and the modulation chip are formed independently, parameter optimization and process processing can be independently performed for the optical chip and the modulation chip, so as to greatly reduce the process difficulty and improve the production yield of the optical integrated device.

### BRIEF DESCRIPTION OF THE DRAWINGS

### Description of the Drawings

In order to more clearly explain the technical solutions in the embodiments of the present application or the conventional technology, the drawings needed to be used in the description of the embodiments or the conventional technology will be briefly introduced below, obviously, the drawings in the following description are merely the embodiments of the present disclosure, person having ordinary skill in the art can also obtain other drawings based on these drawings without exerting creative efforts.

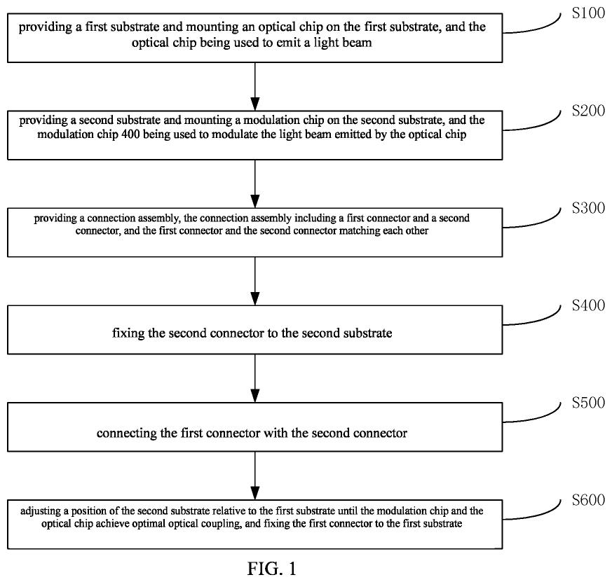

FIG. 1 is a flowchart of a preparation method for an optical integrated device provided in one embodiment;

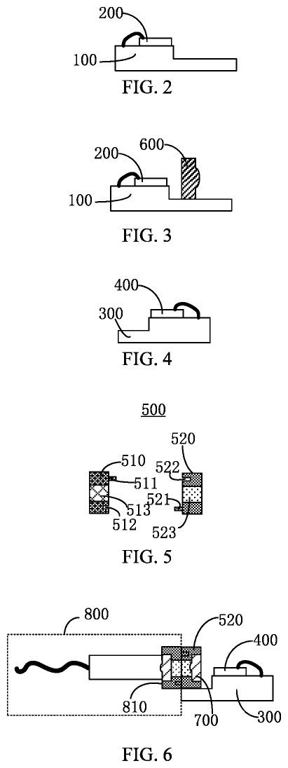

FIGS. 2 to 8 are schematic cross-sectional structural schematic diagrams of the optical integrated device during a preparation process provided in one embodiment;

FIG. 9 is a cross-sectional structural schematic diagram of an optical integrated device provided in one embodiment;

FIG. 10 is a cross-sectional structural schematic diagram of an optical integrated device provided in another embodiment.

### DETAILED DESCRIPTION OF THE EXEMPLARY EMBODIMENTS

### The Exemplary Embodiments of the Present Disclosure

In order to facilitate understanding of the present application, the present application will be described more fully below with reference to the relevant drawings. Embodiments of the present application are given in the accompanying drawings. However, the present application can be implemented in many different forms and is not limited to the embodiments described herein. Rather, these embodiments are provided so that this disclosure of the present application will be thorough and complete.

Unless otherwise defined, all technical and scientific terms used herein have the same meaning as commonly understood by one of ordinary skill in the technical field to which the present application belongs. The terminology used herein in the description of the application is for the purpose of describing specific embodiments only and is not intended to limit the present application.

It will be understood that when an element or layer is referred to as being “on,” “adjacent,” “connected to” or “coupled to” another element or layer, it can be directly on, adjacent to, connected to, or coupled to other elements or layers, or intervening elements or layers may be present. In contrast, when an element is referred to as being “directly on,” “directly adjacent,” “directly connected to” or “directly coupled to” another element or layer, there are no intervening elements or layers present. layer. It will be understood that although the terms first, second, third, etc. may be used to describe various elements, components, regions, layers, doping types and/or sections, these elements, components, regions, layers, doping types and/or sections should not be limited by these terms. These terms are only used to distinguish one element, component, region, layer, doping type or section from another element, component, region, layer, doping type or section. Thus, a first element, component, region, layer, doping type or section discussed below could be termed a second element, component, region, layer or section without departing from the teachings of the application.

Spatial relational terms such as “under”, “under”, “under”, “under”, “on”, “above”, etc., in This may be used to describe the relationship of one element or feature to other elements or features shown in the figures. It will be understood that the spatially relative terms encompass different orientations of the device in use and operation in addition to the orientation depicted in the figures. For example, if the device in the figures is turned over, elements or features described as “below” or “under” or “beneath” other elements or features would then be oriented “above” the other elements or features. Thus, the exemplary terms “below” and “under” may include both upper and lower orientations. Additionally, the device may be otherwise oriented (e.g., rotated 90 degrees or at other orientations) and the spatial descriptors used herein interpreted accordingly.

As used herein, the singular forms “a,” “an,” and “the” may include the plural forms as well, unless the context clearly dictates otherwise. It will also be understood that the terms “comprising” or “having” and the like specify the presence of stated features, integers, steps, operations, components, parts or combinations thereof, but do not exclude the presence or addition of one or more possibility of other features, integers, steps, operations, components, parts or combinations thereof. Also, in this specification, the term “and/or” includes any and all combinations of the associated listed items.

In one embodiment, reference is made to FIG. 1, which provides a preparation method for an optical integrated device, and the preparation method includes:

Step S100, providing a first substrate 100 and mounting an optical chip 200 on the first substrate 100, and the optical chip 200 being used to emit a light beam, as can be referred to in FIG. 2;

step S300, providing a second substrate 300 and mounting a modulation chip 400 on the second substrate 300, and the modulation chip 400 being used to modulate the light beam emitted by the optical chip 200, as can be referred to in FIG. 4;

step S400, providing a connection assembly 500, the connection assembly 500 including a first connector 510 and a second connector 520, and the first connector 510 and the second connector 520 matching each other, as can be referred to in FIG. 5;

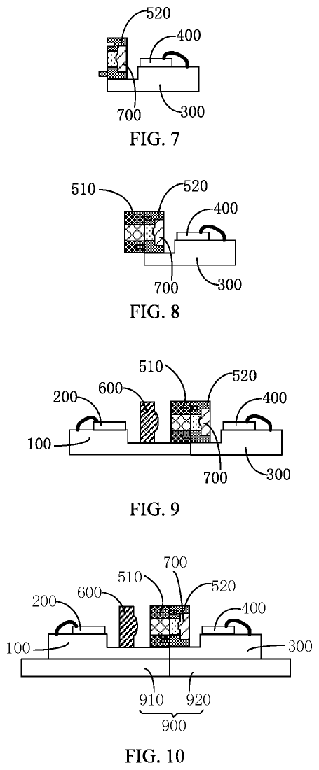

step S800, fixing the second connector 520 to the second substrate 300, as can be referred to in FIG. 7;

step S900, connecting the first connector 510 with the second connector 520, as can be referred to in FIG. 8;

step S1000, adjusting a position of the second substrate 300 relative to the first substrate 100 until the modulation chip 200 and the optical chip 100 achieve optimal optical coupling, and fixing the first connector 510 to the first substrate 100, as can be referred to in FIG. 9.

In step S100, the first substrate 100 is a carrier substrate for the optical chip 200, and can be made of a heat sink material or other substrate materials. Specifically, the optical chip 200 can be mounted on the first substrate 100.

At the same time, in addition to the optical chip, other chips and/or other circuit structures can also be provided on the substrate 100. The optical chip 200 can be electrically connected to the relevant circuits of the first substrate 100 through gold wire bonding, such that the optical chip 200 can be powered by the relevant circuits.

As an example, the optical chip can include a laser chip. More specifically, the optical chip 200 can include a distributed feedback (DFB) laser chip or the like.

In step S300, the second substrate 300 is a carrier substrate for the modulation chip 400, and can be made of the same material as the first substrate, or can be made of a material different from that of the first substrate. Specifically, the modulation chip 400 can be mounted on the modulation chip 400.

At the same time, in addition to the modulation chip 400, other chips and/or other circuit structures can also be provided on the second substrate 300. The modulation chip 400 can be electrically connected to the relevant circuits of the second substrate 200 through gold wire bonding, such that the modulation chip 400 can be applied with reverse bias and high-frequency modulation signals, thereby modulating the light output by the optical chip 200 at high speed.

As an example, the modulation chip 400 can include an electroabsorption modulator chip. Naturally, the modulation chip 400 is not limited to the electroabsorption modulator chip, and can also include a silicon-based modulator chip or a microring modulator chip.

In step S400, the first connector 510 and the second connector 520 of the connection assembly 500 can be provided with positioning structures that cooperate with each other, such that the first connector 510 and the second connector 520 can be detachably connected to each other.

As an example, the first connector 510 and the second connector 520 can be respectively provided with a guide pin and a guide hole that cooperate with each other, such that detachable connection is performed through cooperation of the guide pin and the guide hole.

In step S800, the second connector 520 can be fixed to the second substrate 300 through gluing, laser welding, eutectic soldering, or other methods.

In step S900, the first connector 510 and the second connector 520 can be connected through the positioning structures matching to each other (such as the guide pin and the guide hole) on the first connector 510 and the second connector 520.

In step S1000, a direction from the optical chip 100 toward the adjusting chip can be set as a z-axis direction, two directions perpendicular to the z-axis are respectively an x-axis direction and a y-axis direction, and the y-axis direction is perpendicular to an upper surface of the substrate.

At this time, the first substrate 100 and structural components on the first substrate 100 can be fixed, and at the same time, positions of the second substrate 300 and structural components thereon can be adjusted in x, y, and z directions through a high-precision placement equipment, thereby adjusting a distance and a spatial angle between the first substrate 100 as well as the structural components thereon and the second substrate 300 as well as the structural components thereon.

Naturally, in some embodiments, the second substrate 300 and the structural components thereon can also be fixed while the positions of the first substrate 100 and the structural components thereon are adjusted in the x, y, and z directions by high-precision placement equipment, thereby adjusting the distance and the spatial angle between the first substrate 100 as well as the structural components thereon, and the second substrate 300 as well as the structural components thereon. This application is not limited thereto.

Moreover, during the adjustment made for the position of the second substrate 300 relative to the first substrate 100, an optical power emitted from the optical chip 200 on the first substrate 100 to the modulation chip 400 on the second substrate 300 can also be monitored simultaneously.

When the optical power emitted from the optical chip 200 on the first substrate 100 to the modulation chip 400 on the second substrate 300 is maximum, the modulation chip 400 and the optical chip 200 achieve the optimal optical coupling. At this time, the first connector 510 can be fixed to the first substrate 100 through gluing, laser welding, or eutectic welding, thereby forming the optical integrated device.

Therefore, during the preparation process of the optical integrated device, the second connector 520 serves as both a connector and a coupling alignment tool.

In the method of this embodiment, the optical chip 100 and the modulation chip 400 are mounted on different substrates and then connected through the first connector 510 and the second connector 520 of the connection assembly 500. The matching and mating between high-quality outer surfaces of the first connector 510 and the second connector 520 can ensure that directions of the light beams on both sides are consistent. At the same time, it can effectively avoid the separate epitaxial growths of the optical gain active layer and the modulation absorption layer on the same substrate (i.e., a single substrate), thereby avoiding the high reliability risks associated with performing multiple epitaxial processes for monolithic integration. Moreover, the optical chip 100 and the modulation chip 400 are formed independently, parameter optimization and process processing can be independently performed for the optical chip 100 and the modulation chip 400, so as to greatly reduce the process difficulty and improve the production yield of the optical integrated device.

In one embodiment, after step S100, the preparation method further includes:

Step S200, the first lens structure 600 being installed on the first substrate 100, and the first lens structure 600 being located on one side of the optical chip 200, referring to FIG. 3.

The first lens structure 600 is located on one side of the optical chip 200, such that small mode field beam emitted by the optical chip 200 can be collimated and expanded. The first lens structure 600 can be a micro-optical lens.

As an example, referring to FIG. 3, the first substrate 100 can include a first mounting part 110 and a second mounting part 120 that are connected to each other. A thickness of the first mounting part 110 can be greater than a thickness of the second mounting part 120, so as to provide a step between the first mounting part 110 and the second mounting part 120.

The optical chip 200 with the smaller thickness can be mounted on the first mounting part 110 with the larger thickness, and a direction to which a light is emitted can be controlled to a direction along a direction from the first mounting part 110 toward the second mounting part 120. The first lens structure 600 with the larger thickness can be mounted on the second mounting part 120 with the smaller thickness. At this time, since the first mounting part 110 is thicker than the second mounting part 120, it is beneficial for the optical chip 200 on the first mounting part 110 to emit light toward the center of the first lens structure 600, which is further beneficial for the first lens structure 600 to effectively collimate and expand the small mode field beam emitted by the optical chip 200.

Naturally, a shape of the substrate 100 is not limited thereto, and can be configured according to actual conditions.

In this embodiment, the small mode field beam emitted by the optical chip 200 can be collimated and expanded through the first lens structure 600, such that the small mode field is converted into a large mode field, thereby effectively reducing a precision for aligning and coupling the optical chip 200 to the modulation chip.

Naturally, in other embodiments, the small mode field beam emitted by the optical chip 200 can be collimated and expanded in other ways, and the present application is not limited thereto.

In one embodiment, step S200 includes:

Step S210, adjusting a distance of the first lens structure 600 relative to the optical chip 200;

step S220, mounting the first lens structure 600 on the first substrate 100.

In step S210, specifically, as an example, when a direction from the optical chip toward the adjusting chip 400 is set as the z-axis direction, two directions perpendicular to the z-axis being respectively the x-axis direction and the y-axis direction and the y-axis direction being perpendicular to the upper surface of the substrate, positions of the first lens structure 600 in the z-axis direction and the x-axis direction can be adjusted through relevant instruments and equipment, such that the light beam emitted by the optical chip 200 can form a light beam with higher collimation after passing through the first lens structure 600, thus facilitating effective optical coupling with the optical fiber.

It can be understood that the position of the first lens structure 600 in the y-axis direction can be reasonably controlled through process treating.

In step S220, the position-adjusted first lens structure 600 is mounted on the first substrate 100.

In one embodiment, before step S800, the preparation method further includes:

Step S500, connecting and assembling the second connector 520 with the second lens structure 700, referring to FIG. 6.

Specifically, the second lens structure 700 can be integrated and mounted on the second connector 520 through precision placement. The second lens structure 700 can be a micro-optical lens.

In this embodiment, the second lens structure 700 has a collimating beam expansion function, which can achieve a conversion between a large mode field and a small mode field, thereby greatly reducing the precision requirements for aligning and coupling the optical chip 200 to the adjusting chip 400.

At the same time, the second lens structure 700 is assembled on the second connector 520, such that the second lens structure 700 can be fixed to the second substrate 300 at the same time as the second connector 520, thereby simplifying the process.

Naturally, in other embodiments, the second lens structure 700 and the second connector 520 can also be fixed at different positions on the second substrate 300, and the present application is not limited thereto.

Specifically, in some embodiments, during the preparation process of the optical integrated device, a light beam can be emitted by the optical chip 200, and then the light beam emitted by the optical chip 200 can be collimated and expanded through the first lens structure 600 to convert the small mode field to the large mode field, and then the large mode field beam is converted into a small mode field beam through the second lens structure 700 and to be emitted to a waveguide of the adjusting chip 400.

In one embodiment, after step S500, the preparation method further includes:

Step S600, focusing and coupling an external collimated beam to the modulation chip 400 through the second lens structure 700;

step S700, adjusting the position of the second lens structure 700 relative to the modulation chip 400 until the modulation chip 400 achieves optimal coupling for the external collimated beam.

In step S600, the external collimated light beam can be coupled from one side of the second lens structure 700 through the second lens structure 700 to the waveguide of the modulation chip 400 located on another side of the second lens structure 700.

In step S700, it can be understood that since the second lens structure 700 is assembled on the second connector 520, the position of the second lens structure 700 relative to the modulation chip 400 being adjusted means that the position of the second lens structure 700 relative to the modulation chip 400 is also adjusted.

Specifically, as an example, when a direction from the optical chip 200 toward the adjusting chip 400 is set as the z-axis direction, two directions perpendicular to the z-axis being respectively the x-axis direction and the y-axis direction, and the y-axis direction being perpendicular to the upper surface of the substrate, positions of the second lens structure 700 in the z-axis direction and the x-axis direction can be adjusted through relevant instruments and equipment, thus facilitating effective optical coupling between the modulation chip 400 and the optical chip 200.

It can be understood that the position of the second lens structure 700 in the y-axis direction can be reasonably controlled through process treating.

At this time, in step S800, the position-adjusted second lens structure 700 is mounted on the second substrate 300 along with the second connector 520.

In one embodiment, referring to FIG. 6, step S600 includes:

Step S610, providing an optical fiber collimator assembly 800, the optical fiber collimator assembly 800 including a third connector 810, and the third connector 810 and the second connector 520 matching each other;

step S620, connecting the third connector 810 with the second connector 520;

S630: emitting the external collimated beam through the optical fiber collimator assembly 800.

In step S610, a positioning structure matching to the second connector 520 can be provided on the third connector 810 (such as a guide pin and a guide hole), such that the second connector 520 and the third connector 810 can be detachably connected to each other.

In step S620, the third connector 810 and the second connector 520 can be connected through their positioning structures matching to each other.

In step S630, the external collimated light beam can be emitted from the optical fiber collimator assembly 800 to the waveguide of the modulation chip 400 located on another side of the second lens structure 700.

Then, in step S700, the fiber collimator assembly 800 is used to drive the position of the second connector 520 where the second lens structure 700 is located, and then the position of the second lens structure 700 relative to the modulation chip 400 is adjusted until the modulation chip 400 achieves the optimal coupling for the external collimated beam.

Then in step S800, the second lens structure 700 is fixed on the second substrate 300 along with the second connector 520. The second connector 520 and the third connector 810 are then disassembled, thereby removing the optical fiber collimator assembly 800.

In this embodiment, by providing the optical fiber collimator assembly 800 on the third connector 810 (which matches the second connector 520), the optical fiber collimator assembly 800 can thus emit the external collimated beam stably and reliably when the third connector 810 is connected to the second connector 520.

In one embodiment, referring to FIG. 5, the first connector 510 includes a first guide pin 511 and a first guide hole 512. The second connector 520 includes a second guide pin 521 and a second guide hole 522.

The first guide pins 511 and the second guide hole 522 are provided correspondingly, such that they can cooperate with each other to connect the first connector 510 with the second connector 520. At the same time, the second guide pin 521 and the first guide hole 512 are provided correspondingly, so that they can cooperate with each other to connect the first connector 510 to the second connector 520.

In this embodiment, both the first connector 510 and the second connector 520 have guide pins and guide holes, thereby making the connection between the first connector 510 and the second connector 520 more stable.

Specifically, the first connector 510 can further include a first light-transmitting portion 513. The first light-transmitting portion 513 is located in the center of the second connector 520, such that the light from the optical chip 200 can pass through the first light-transmitting portion 513 when the first connector 510 is fixed to the first substrate 100.

Similarly, the second connector 520 can further include a second light-transmitting portion 523. The second light-transmitting portion 523 is located in the center of the second connector 520, such that the second light-transmitting portion 523 faces the modulation chip 400 when the second connector 520 is fixed to the second substrate 300, thereby allowing light to pass through.

It can be understood that specific forms of the first connector 510 and the second connector 520 are not limited thereto, for example, the first connector 510 can only be provided with the guide pin, and the second connector 520 can only be provided with the guide hole matching the guide pin.

It should be understood that although various steps in the flowchart of FIG. 1 are shown in sequence as indicated by arrows, these steps are not necessarily executed in the order indicated by arrows. Unless explicitly stated in this article, there is no strict order restriction on the execution of these steps, and these steps can be executed in other orders. Moreover, at least some of the steps in FIG. 1 can include multiple steps or stages, these steps or stages are not necessarily executed at the same time, but can be executed at different times, an execution order of these steps or stages does not necessarily need to be performed sequentially, but can be performed in turn or alternately with other steps or at least part of steps or stages in other steps.

In one embodiment, an optical integrated device is further provided, referring to FIG. 9, the optical integrated device includes: a first substrate 100, an optical chip 200, a second substrate 300, a modulation chip 400 and a connection assembly 500.

The optical chip 200 is mounted on the first substrate 100. The optical chip 200 is used to emit a light beam.

The modulation chip 400 is mounted on the second substrate 300. The modulation chip 400 is used to modulate the light beam emitted by the optical chip 200.

The connection assembly 500 includes a first connector 510 and a second connector 520, the first connector 510 and the second connector 520 match each other, the second connector 520 is fixed to the second substrate 300, and the first connector 510 is fixed to the first substrate 100.

In one embodiment, the optical integrated device further includes a first lens structure 600. The first lens structure 600 is located on the first substrate 100 and on one side of the optical chip 200 close to the modulation chip 400.

In one embodiment, the optical integrated device further includes a second lens structure 700. The second lens structure 700 is located on the second substrate 300 and on one side of the modulation chip close to the optical chip 200.

In one embodiment, the first connector 510 includes a first guide pin 511 and a first guide hole 512. The second connector 520 includes a second guide pin 521 and a second guide hole 522;

the first guide pin 511 is provided correspondingly to the second guide hole 522, and the second guide pin 521 is provided correspondingly to the first guide hole 512.

In one embodiment, referring to FIG. 10, the optical integrated device further includes a heat dissipation assembly 900. The heat dissipation assembly 900 includes a first heat dissipation plate 910 and a second heat dissipation plate 920. The first heat dissipation plate 910 is connected to one side of the first substrate 100 on which the optical chip 200 is not mounted. The second heat dissipation plate 920 is connected to one side of the second substrate 300 on which the modulation chip 400 is not mounted.

The first heat dissipation plate 910 and the second heat dissipation plate 920 can effectively dissipate heat from the optical integrated device. Specifically, materials of the first heat dissipation plate 910 and the second heat dissipation plate 920 can be metal materials, and the materials of the first heat dissipation plate 910 and the second heat dissipation plate 920 can be the same or different, and are limited thereto.

At the same time, the first heat dissipation plate 910 can be mounted on the first substrate 100 before the optical chip 200 and other components are mounted on the first substrate 100, or the first heat dissipation plate 910 can be mounted on the first substrate 100 after the optical chip 200 and other components are mounted on the first substrate 100. The second heat dissipation plate 920 can be mounted on the second substrate 300 before the modulation chip 400 and other components are mounted on the second substrate 300, or the second heat dissipation plate 920 can be mounted on the second substrate 300 after the modulation chip 400 and other components are mounted on the second substrate 300.

For specific limitations on the optical integrated device, reference can be made to the above limitations on the preparation method for the optical integrated device, which will not be described again here.

In the description of this specification, reference to the description of the terms “one embodiment,” “other embodiments,” etc., means that a specific feature, structure, material, or characteristic described in connection with the embodiment or example is included in at least one embodiment or example of the present application. In this specification, schematic descriptions of the above terms do not necessarily refer to the same embodiment or example.

The technical features of the above embodiments can be combined in any way, to simplify the description, not all possible combinations of the technical features of the above embodiments are described. However, as long as there is no contradiction in the combination of these technical features, all possible combinations should be considered to be within the scope of this specification.

The above-described embodiments only express several implementation modes of the present application, and their descriptions are relatively specific and detailed, but should not be construed as limiting the scope of the patent application. It should be noted that, for those having ordinary skill in the art, several modifications and improvements can be made without departing from the concept of the present application, and these all fall within the protection scope of the present application. Therefore, the scope of this patent application should be determined by the appended claims.

What is claimed is:

1. A preparation method for an optical integrated device, wherein the preparation method comprises:
providing a first substrate, and mounting an optical chip on the first substrate, the optical chip being used to emit a light beam;
providing a second substrate, and mounting a modulation chip on the second substrate, the modulation chip being used to modulate the light beam emitted by the optical chip;
providing a connection assembly, the connection assembly including a first connector and a second connector, and the first connector and the second connector matching each other;
fixing the second connector to the second substrate;
connecting the first connector to the second connector;
adjusting a position of the second substrate relative to the first substrate until the modulation chip and the optical chip achieve optimal optical coupling, and fixing the first connector to the first substrate.

2. The preparation method for the optical integrated device according to claim 1, wherein the optical chip includes a laser chip, and the modulation chip includes an electro-absorption modulator chip, a silicon-based modulator chip, or a microring modulator chip.

3. The preparation method for the optical integrated device according to claim 1, wherein after providing a first substrate and mounting an optical chip on the first substrate, the preparation method further comprises:
mounting a first lens structure on the first substrate, and the first lens structure being located on one side of the optical chip.

4. The preparation method for the optical integrated device according to claim 3, wherein mounting a first lens structure on the first substrate further includes:
adjusting a position of the first lens structure relative to the optical chip;
mounting the first lens structure on the first substrate.

5. The preparation method for the optical integrated device according to claim 1, wherein before fixing the second connector to the second substrate, the preparation method further comprises:
connecting and assembling the second connector with a second lens structure.

6. The preparation method for the optical integrated device according to claim 5, wherein after connecting and assembling the second connector with a second lens structure, the preparation method further comprises:
focusing and coupling an external collimated beam to the modulation chip through the second lens structure;
adjusting the position of the second lens structure relative to the modulation chip until the modulation chip achieves optimal coupling for the external collimated beam.

7. The preparation method for the optical integrated device according to claim 6, wherein focusing and coupling an external collimated beam to the modulation chip through the second lens structure further includes:
providing an optical fiber collimator assembly, the optical fiber collimator assembly including a third connector, and the third connector and the second connector matching each other;
connecting the third connector to the second connector;
emitting the external collimated beam through the optical fiber collimator assembly.

8. An optical integrated device, wherein the optical integrated device comprises:
a first substrate, an optical chip being mounted on the first substrate, and the optical chip being used to emit a light beam;
a second substrate, a modulation chip being mounted on the second substrate, and the modulation chip being used to modulate the light beam emitted by the optical chip;
a connection assembly, the connection assembly including a first connector and a second connector, the first connector and the second connector matching each other, the second connector being fixed to the second substrate, and the first connector being fixed to the first substrate.

9. The optical integrated device according to claim 8, wherein the optical integrated device further comprises a first lens structure, the first lens structure is located on the first substrate, and is located on a side of the optical chip close to the modulation chip.

10. The optical integrated device according to claim 8, wherein the optical integrated device further comprises a second lens structure, the second lens structure is located on the second substrate, and is located on a side of the modulation chip close to the optical chip.

11. The optical integrated device according to claim 10, wherein the second lens structure is assembled on the second connector.

12. The optical integrated device according to claim 8, wherein:
the first connector includes a first guide pin and a first guide hole;
the second connector includes a second guide pin and a second guide hole;
the first guide pin is arranged corresponding to the second guide hole, and the second guide pin is arranged corresponding to the first guide hole.

13. The optical integrated device according to claim 8, wherein the optical integrated device further comprises a heat dissipation component, the heat dissipation component includes a first heat dissipation plate and a second heat dissipation plate, the first heat dissipation plate is connected to a side of the first substrate where the optical chip is not mounted, and the second heat dissipation plate is connected to a side of the second substrate where the modulation chip is not mounted.
